(19) United States
(12) Patent Application Publication
(10) Pub. No.: US 2011/0206244 A1
(43) Pub. Date: Aug. 25, 2011

(54) SYSTEMS AND METHODS FOR ENHANCED BIOMETRIC SECURITY

(76) Inventor: Carlos Munoz-Bustamante, Durham, NC (US)

(21) Appl. No.: 12/712,747

(22) Filed: Feb. 25, 2010

(51) Int. Cl. G06K 9/00

(52) U.S. Cl. 382/118

(57) ABSTRACT

Embodiments of the invention provide biometrics systems having enhanced security. Embodiments of the invention provide facial recognition systems implemented for access control purposes, such as a biometrics access control system for an electronic device, in which modified and/or additional challenges via a facial recognition system are made prior to granting access to the protected device.

### BACKGROUND

The subject matter presented herein generally relates to biometrics systems used in security applications. For example, biometrics systems are utilized for access control systems in electronic devices.

Biometrics comprises methods for uniquely recognizing humans based on one or more intrinsic physical traits. Information technology systems commonly use biometrics as a form of access management/control.

Biometrics systems are becoming increasingly popular. Biometrics systems are being used for access control on electronic devices, such as computer systems. For example, some laptop personal computers (laptop PCs) come equipped with one or more biometrics systems which “password” protects the laptop PC from unauthorized access.

For example, some laptop PCs are currently equipped with one or more biometrics systems, such as a fingerprint reader and/or a facial recognition system. Facial biometrics systems and their application in user authentication are becoming of particular interest because of their ease of use and marketability. Facial recognition systems operate generally on the premise that facial features (geographic features of the face such as eyes, nose, mouth, et cetera) of users are unique and can be measured and compared against a reference for identification/authentication.

### BRIEF SUMMARY

Embodiments of the invention provide systems, methods, apparatuses and program storage devices configured to enhance the security and robustness of biometrics systems. Exemplary embodiments provide enhanced security to facial recognition systems implemented for access control purposes, such as a biometrics access control system for an electronic device. Exemplary embodiments of the invention provide for modified and/or additional challenges via a facial recognition system prior to granting access to the protected device.

In summary, one aspect of the invention provides an apparatus comprising: one or more processors; and a program storage device tangibly embodying a program of instructions executable by the one or more processors, the program of instructions comprising: computer readable program code configured to prompt a user for image data; computer readable program code configured to process image data input in response to the prompt; computer readable program code configured to determine if the image data input matches reference image data; and computer readable program code configured to grant access to the apparatus responsive to a match; wherein the reference image data corresponds to one of non-stylized facial pose data of an enrolled user and composite reference image data derived from a series of facial poses of the enrolled user.

Another aspect of the invention provides a method comprising: prompting a user for image data at an apparatus; processing image data input to the apparatus in response to the prompt; determining if the image data input matches reference image data; and granting access to the apparatus responsive to a match; wherein the reference image data corresponds to one of non-stylized facial pose data of an enrolled user and composite reference image data derived from a series of facial poses of the enrolled user.

A further aspect of the invention provides a computer program product comprising: a computer readable storage medium having computer readable program code embodied therewith, the computer readable program code comprising: computer readable program code configured to prompt a user for image data at an apparatus; computer readable program code configured to process image data input to the apparatus in response to the prompt; computer readable program code configured to determine if the image data input matches reference image data; and computer readable program code configured to grant access to the apparatus responsive to a match; wherein the reference image data corresponds to one of non-stylized facial pose data of an enrolled user and composite reference image data derived from a series of facial poses of the enrolled user.

The foregoing is a summary and thus may contain simplifications, generalizations, and omissions of detail; consequently, those skilled in the art will appreciate that the summary is illustrative only and is not intended to be in any way limiting.

For a better understanding of the embodiments of the invention, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an exemplary facial recognition system overview.

FIG. 2 illustrates a flow for an exemplary facial recognition system.

FIG. 3 illustrates a flow for a facial recognition system according to an embodiment.

FIG. 4 illustrates a flow for a facial recognition system according to an embodiment.

FIG. 5 illustrates a flow for a facial recognition system according to an embodiment.

FIG. 6 illustrates a computer system according to an embodiment.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the present invention, as represented in the figures, is not intended to limit the scope of the invention, as claimed, but is merely representative of selected exemplary embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that aspects of the invention can be practiced without one or more of the specific details, or with other methods, components, materials, et cetera. In other instances, well-known structures, materials, or operations are not shown or described in detail to avoid obfuscation.

Embodiments of the invention provide systems, methods, apparatuses and program storage devices configured to enhance the security and robustness of biometrics systems. Embodiments of the invention provide enhanced security to facial recognition systems implemented for example as access control systems, such as a biometrics access control system for an electronic device. Embodiments of the invention provide for modified and/or additional challenges via a facial recognition system prior to granting access to the protected device.

The illustrated embodiments of the invention will be best understood by reference to the Figures. The following description is intended only by way of example, and simply illustrates certain selected exemplary embodiments of the invention as claimed herein.

In order to more fully understand certain aspects of the invention, and as a non-limiting and exemplary implementation environment, embodiments of the invention are described in connection with facial recognition systems such as those described in co-pending and commonly assigned Chinese Patent Applications CN 200510112508.1, entitled “Computer login system with expression identification function and method therefor” (published as European Patent Office Publication No. CN1940806 (A)), filed on Sep. 30, 2005 and CN 200510112509.6, entitled “Computer authorizing monitoring system with image identification function and its method” (published as European Patent Office Publication No. CN1940807 (A)), filed on Sep. 30, 2005, both of which are incorporated by reference here. Embodiments of the invention operate in an environment similar to the VeriFace® facial recognition system, offered in connection with laptop PCs produced by Lenovo (US) Inc. of Morrisville, N.C. However, it should be understood that these facial recognition systems are simply used as examples that may be useful to highlight and contrast certain aspects of the various embodiments of the invention, as described herein.

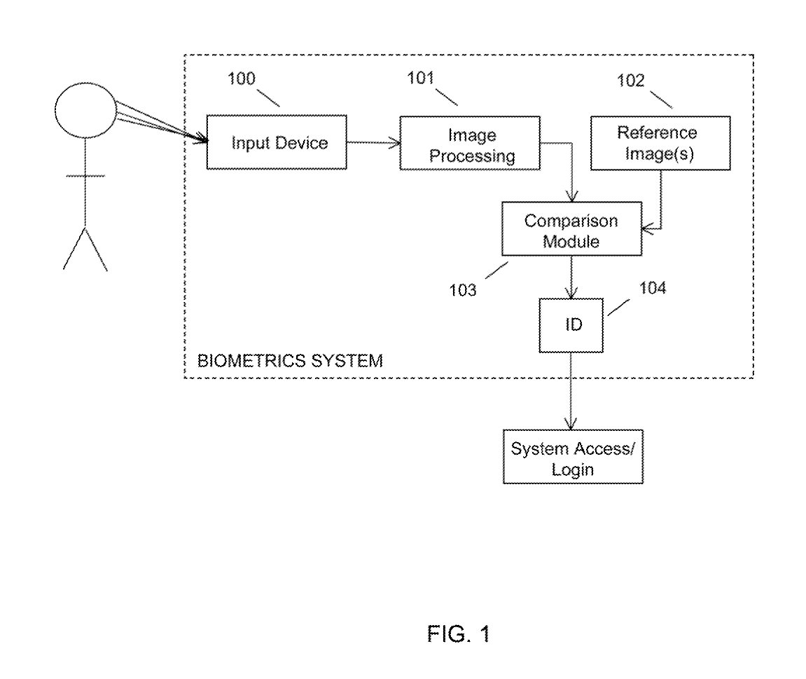

Referring to FIG. 1, the VeriFace® facial recognition system is a biometrics system that utilizes facial recognition to do, for example, a Windows® operating system login. VeriFace® facial recognition system will provide a camera window in a login frame (displayed on a display device) as an initial password prompt, that is, as an access control measure. The user positions his or her face (as captured by an input device 100 such as a camera) in the window. This allows an input device 100 to capture input image data. Windows® is a registered trademark of Microsoft Corporation in the United States and other countries. VeriFace® is a registered trademark of Lenovo (Beijing) Limited Corporation of China in the United States and other countries.

The input image data comprises some form of electromagnetic radiation captured by the input device 100. As is understood by those having ordinary skill in the art, various varieties of electromagnetic radiation can be utilized to capture an image of a user's facial features, for example from the visible and/or infrared spectrums. In the simplest implementation, visible spectrum electromagnetic radiation is utilized, as captured by a digital camera, though this is simply a non-limiting example. Different types of input image data will offer different features of the captured image.

The input image data is passed to an image processing module 101 that processes the input image data to reduce it to a comparable format. The processing of input image data can take many forms, however, one having ordinary skill in the art will recognize that regardless of the processing, the end result only need be that a consistent representation of the captured image data is produced, suitable for comparison with reference image data (or processed representations thereof).

Accordingly, once a fresh image is captured from the user in a log in attempt, a reference image of the user is retrieved from a storage device 102 in order to process the access control challenge. The reference images may be produced in the same manner as the input image data and stored locally or remotely for later use as a reference (that is, a user may enroll his or her image data into the system).

The reference image and the input image are compared by a comparison module 103 to determine if the input image data matches the reference data. In other words, the comparison module is configured to compare the processed image data (picture) of the user with a processed reference image to determine a match according to a predetermined threshold. If there is a match of sufficient quality, the user is identified 104 and granted access to the system (for example, the laptop computer system proceeds with the log in successfully). If no match is made, the process can be repeated.

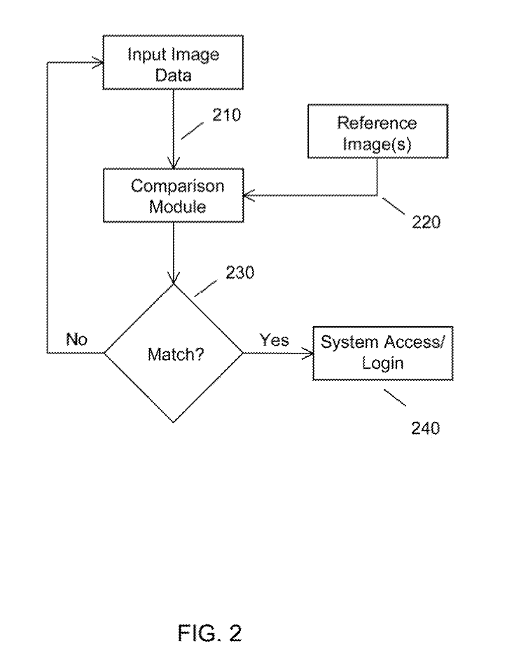

Thus, as outlined in FIG. 2, a facial recognition system can capture the user's input image data 210, fetch a reference image 220, compare these to determine a match 230, and if an appropriate match if made, grant access to the system 240. Such biometrics systems operate in a smooth and automatic fashion by recognizing the user's face (distinguishable features thereof) and, in response to an appropriate match, logging in the user automatically. While biometrics systems such as this have proven easy to use, workable and thus highly desirable, increased security is also sometimes desirable. Thus, embodiments of the invention provide for alternative and/or additional challenges prior to permitting log in via such a biometrics system.

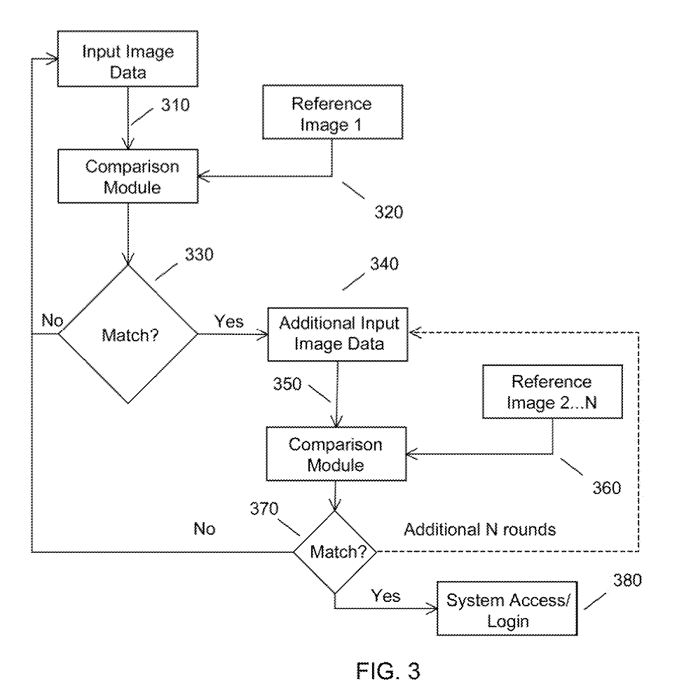

Turning to FIG. 3, a flow of a biometrics access control system according to an embodiment of the invention is illustrated. As above, the user inputs image data 310 to the biometrics system comparison module and this image data is used by the comparison module to compare with a fetched reference image 320 (data representation). As in FIG. 2, the reference image and the captured image are typically standard, stylized images of the user. Thus, these images typically correspond to a portrait style pose such as that taken for a driver's license or photo identification card.

The inventor has recognized, however, that utilizing only a standard, stylized pose to produce enrollment (reference) images and login (fresh images) renders the system susceptible to unauthorized access. In this scenario, a standard, stylized image may be replicated or imitated by an unauthorized user in a variety of ways. For example, an unauthorized user may obtain a stylized photo of the authorized user from a wide variety of sources, such as the Internet.

Thus, embodiments of the invention provide for additional challenges over and above the first, a stylized, standard image challenge. Responsive to a match with the standard, stylized image, an additional challenge may be issued and the user is prompted to input further image data at 340. The additional image data required is distinct from the first input image, such that another reference image (for example, reference image 2) is utilized for comparison.

The additional image data preferrably corresponds to a non-stylized pose. This can take any of a wide variety of forms; however, the non-stylized pose is preferably distinct and unusual such that a standard photo of the user would not correspond to it. The user likewise enrolls the non-stylized pose into the system at a prior time.

In response to the additional input image data being received 350, the second reference image data is fetched 360 and input into the comparison module for comparison. If a match is found 370, the user can be authenticated and granted access to the system 380.

In another embodiment, the user may be required to enroll more than one non-stylized pose and input image data corresponding to those non-stylized poses for repeated verification by the system prior to being granted access to the system. This would correspond to an iterated challenge process utilizing several or a series of non-stylized poses. Accordingly, varying levels or layers of security can be added to the biometrics system according to an embodiment of the invention.

A facial recognition system is optimally suited for providing such non-stylized poses, which can be thought of as secret faces, as the face is a somewhat unique biometrics reference point inasmuch as it can be easily and memorably modified to provide different inputs. For example, a user may choose as their non-stylized pose (secret face) a pose where the user opens his or her mouth as wide as possible, or the like. Thus, a standard photograph accessed by an unauthorized user has little chance at matching the non-stylized pose adequately to be susceptible to unauthorized access attempts. Moreover, if the unauthorized user would need to double the amount of fraudulent image data obtained (if the system is implemented in a two-challenge design).

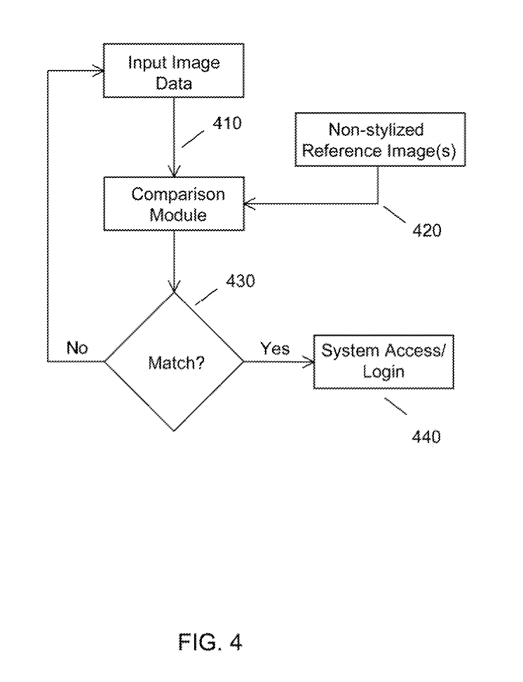

Referring now to FIG. 4, another embodiment of the invention is configured to utilize the non-stylized image alone as the access control measure. Thus, the challenge issued to the user is that of a non-stylized image rather than a standard, stylized image. Thus, the user is prompted for non-stylized image input. The user makes a secret face, previously enrolled in the system. The user's image data is input into the comparison module 410 along with the reference non-stylized image 420. If a match 430 is determined, the user is granted access to the system 440.

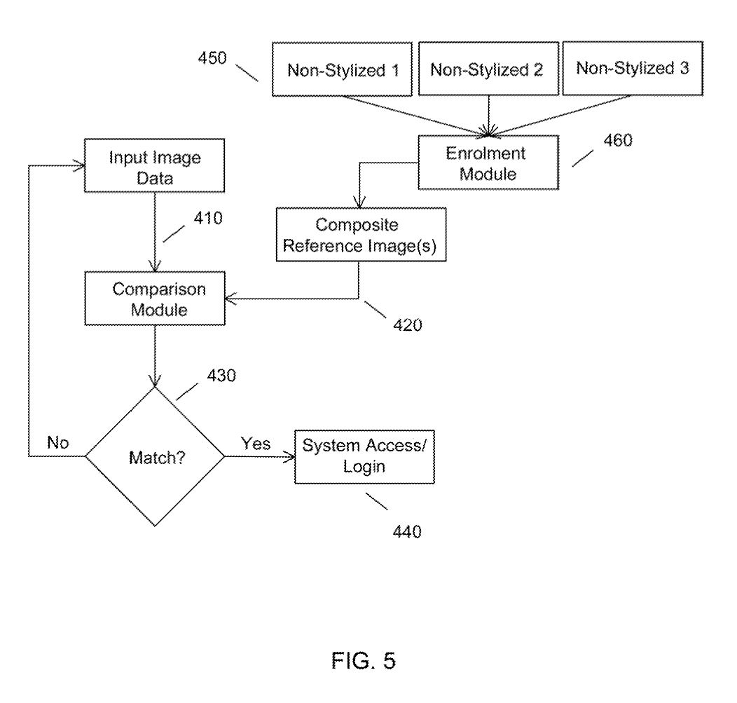

Regarding FIG. 5, an embodiment of the invention is configured to allow the user to enroll a series of non-stylized images 450 into an enrollment module 460 of the system (via the input device, not shown), similar to enrolling standard, stylized images. However, the enrollment module is configured to create composite image data from a series of images, from which three-dimensional relationships can be drawn from various facial features captured from various two dimensional views. The composite image data can have a three dimensional character. Thus, non-stylized images 1-3 may be image captures of the user with his or her head angled to the left (relative to the camera), to the right, and at any angle in between, for example, 20 degrees. The enrollment module is configured to process the non-stylized images to produce one or more composite reference images that can be compared to the user input. Although non-stylized images are used in this example, in another embodiment, stylized images may be used, three or more.

When the user is challenged to provide input data, the user poses as he or she enrolled in the series, that is for example head to the left, to the right and at a 20 degree angle, as in the example given above. These image captures are processed similar to those previously enrolled to produce a composite image (data representation thereof), used for comparison with the reference composite image. This gives the image data an almost three-dimensional character as the reference points captured on the user's face (eyes, nose, et cetera) are at different orientations and angles with respect to one another throughout the series. Moreover, the series may be required to be performed in order, adding another layer of complexity to the composite image data produced. Accordingly, an embodiment of the invention utilizing the composite image scheme offers increased levels of security. Although three images are used in this example, in another embodiment, more than three images can be taken.

It should be understood that although several non-limiting examples have been described herein to highlight certain aspects of the invention, the embodiments of the invention are not so limited. For example, an embodiment utilizing the composite image scheme can be combined with any of the other described embodiments, as desired.

It will be understood by those having ordinary skill in the art that the embodiments of the invention can be implemented with electronic devices with appropriately configured circuitry, such as a computer system, a smart phone, a personal digital assistant and the like. A non-limiting and exemplary computer system is described below.

The term “circuit” or “circuitry” as used herein includes all levels of available integration, for example, from discrete logic circuits to the highest level of circuit integration such as VLSI, and includes programmable logic components programmed to perform the functions of an embodiment as well as general-purpose or special-purpose processors programmed with instructions to perform those functions.

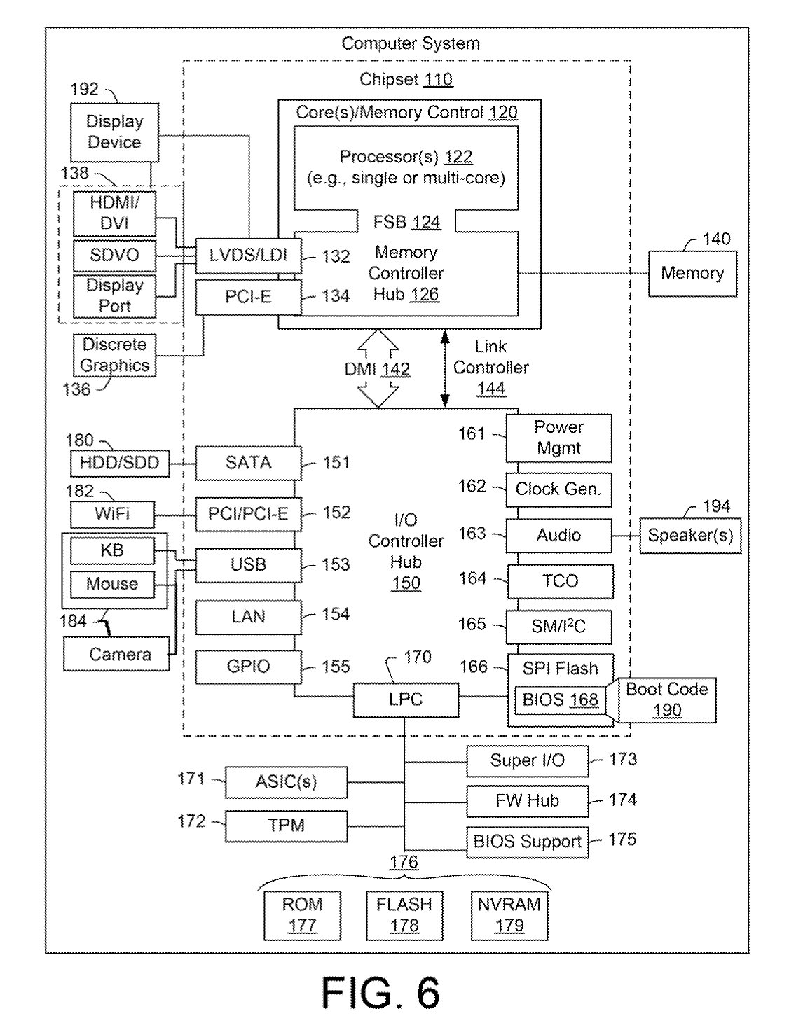

While various exemplary circuits or circuitry may be utilized, FIG. 6 depicts a block diagram of an illustrative, exemplary computer system. The system may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine may include other features or only some of the features of the system illustrated in FIG. 6.

The computer system of FIG. 6 includes a so-called chipset 110 (a group of integrated circuits, or chips, that work together, chipsets) with an architecture that may vary depending on manufacturer (for example, INTEL°, AMD®, etc.). The architecture of the chipset 110 includes a core and memory control group 120 and an I/O controller hub 150 that exchange information (for example, data, signals, commands, et cetera) via a direct management interface (DMI) 142 or a link controller 144. In FIG. 6, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 6, the memory controller hub 126 interfaces with memory 140 (for example, to provide support for a type of RAM that may be referred to as “system memory”). The memory controller hub 126 further includes a LVDS interface 132 for a display device 192 (for example, a CRT, a flat panel, a projector, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 6, the I/O hub controller 150 includes a SATA interface 151 (for example, for HDDs, SDDs, et cetera), a PCI-E interface 152 (for example, for wireless connections 182), a USB interface 153 (for example, for input devices 184 such as keyboard, mice, cameras, phones, storage, et cetera.), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations accessed, for example, according to instructions of the BIOS 168. As described herein, a device may include fewer or more features than shown in the system of FIG. 6.

Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. An apparatus comprising:
one or more processors; and
a program storage device tangibly embodying a program of instructions executable by the one or more processors, the program of instructions comprising:
computer readable program code configured to prompt a user for image data;
computer readable program code configured to process image data input in response to the prompt;
computer readable program code configured to determine if the image data input matches reference image data; and
computer readable program code configured to grant access to the apparatus responsive to a match;
wherein the reference image data corresponds to one of non-stylized facial pose data of an enrolled user and composite reference image data derived from a series of facial poses of the enrolled user.

2. The apparatus according to claim 1, wherein the computer readable program code configured to obtain user image data is further configured to obtain additional user image data in response to the match prior to granting access to the apparatus.

3. The apparatus according to claim 1, wherein the computer readable program code configured to prompt a user for image data is further configured to prompt the user for image data corresponding to a stylized pose and image data corresponding to a non-stylized pose; and
wherein the reference image data further comprises reference image data corresponding to a stylized facial pose of the enrolled user.

4. The apparatus according to claim 1, wherein the composite reference image data is derived from a series of non-stylized facial poses of the enrolled user and wherein the computer readable program code configured to prompt a user for image data is further configured to prompt the user for image data corresponding to a series of non-stylized facial poses of the enrolled user.

5. The apparatus according to claim 4, wherein the computer readable program code configured to process the image data input in response to the prompt is further configured to construct composite image data derived from a series of image data inputs received in response to receiving image data from the user corresponding to a series of non-stylized facial poses.

6. The apparatus according to claim 1, further comprising a digital camera configured to capture the image data input in response to the prompt.

7. The apparatus according to claim 1, further comprising a storage device configured to store the reference image data.

8. The apparatus according to claim 1, wherein to grant access to the apparatus responsive to a match further comprises completing a log in sequence.

9. The apparatus according to claim 1, wherein the apparatus is a laptop computer.

10. A method comprising:
prompting a user for image data at an apparatus;
processing image data input to the apparatus in response to the prompt;
determining if the image data input matches reference image data; and
granting access to the apparatus responsive to a match;
wherein the reference image data corresponds to one of non-stylized facial pose data of an enrolled user and composite reference image data derived from a series of facial poses of the enrolled user.

11. The method according to claim 10, wherein prompting a user further comprises prompting the user for additional image input data in response to the match prior to granting access to the apparatus.

12. The method according to claim 10, wherein prompting a user further comprises prompting the user for image data corresponding to a stylized pose and image data corresponding to a non-stylized pose; and
wherein the reference image data further comprises reference image data corresponding to a stylized facial pose of the enrolled user.

13. The method according to claim 10, wherein the composite reference image is derived from a series of non-stylized facial poses of the enrolled user and wherein prompting a user further comprises prompting the user for image data corresponding to a series of non-stylized facial poses of the enrolled user.

14. The method according to claim 13, wherein processing the image data further comprises constructing composite image data derived from a series of image data inputs received in response to receiving image data from the user corresponding to a series of non-stylized facial poses.

15. The method according to claim 10, further comprising receiving via a digital camera operably connected to the apparatus the image data input in response to the prompt.

16. The method according to claim 10, further comprising fetching the reference image data from a storage device.

17. The method according to claim 10, wherein granting access to the apparatus responsive to a match further comprises completing a log in sequence.

18. The method according to claim 10, wherein the apparatus is a laptop computer.

19. A computer program product comprising:
a computer readable storage medium having computer readable program code embodied therewith, the computer readable program code comprising:
computer readable program code configured to prompt a user for image data at an apparatus;
computer readable program code configured to process image data input to the apparatus in response to the prompt;
computer readable program code configured to determine if the image data input matches reference image data; and
computer readable program code configured to grant access to the apparatus responsive to a match;
wherein the reference image data corresponds to one of non-stylized facial pose data of an enrolled user and composite reference image data derived from a series of facial poses of the enrolled user.
